(19) United States
(12) Patent Application Publication
(10) Pub. No.: US 2005/0056503 A1
(43) Pub. Date: Mar. 17, 2005

(54) Filament wound strut and method of making same

(76) Inventor: Brian Jones, San Gabriel, CA (US)

Correspondence Address: ROBERT J. SCHAAP, Suite 188, 21241 Ventura Boulevard, Woodland Hills, CA, 91364, US

(21) Appl. No.: 10/726,314

(22) Filed: Dec. 1, 2003

Related U.S. Application Data
(60) Provisional application No. 60/489,538, filed on Jul. 22, 2003.

(51) Int. Cl. F16F 9/00

(52) U.S. Cl. 188/321.11

(57) ABSTRACT

A filament wound strut as well as a method of making the strut. The filament wound strut has a cylindrical section merging into ends through tapered end sections and which ends may be forked or otherwise arranged to receive a lug fitting. The flat ends may be provided with a specially designed pre-form having a generally oval shape, and which is formed by filament reinforcement in a racetrack format surrounding a quasi-isotropic laminate. In accordance with this construction, the wound structure will react to tension loads and the inner laminate reacts to compression loads, while minimizing the load transfer through edge bearing and shear. A method of producing the strut is also provided in which filament materials are wound about a mandrel with proper winding pattern and sufficient thickness to produce the desired axial stiffness and the required strength in each of the end sections. Thereafter, the material may be consolidated and polymerized in an autoclave.

### RELATED APPLICATIONS

This application is based on and claims for priority, the filing date of my co-pending U.S. Provisional Patent application Ser. No. 60/489,538, filed Jul. 22, 2003.

### BACKGROUND OF THE INVENTION

1. Field of the Invention

This invention relates in general to certain new and useful improvements in filament wound struts as well as a method of making same and, more particularly, to filament wound struts constructed in such manner that they are effective in reacting to tension loads as well as to compression loads in such manner to minimize transfer of such loads into the composite material through edge bearing and shear modes.

2. Brief Description of Related Art

Struts are used to absorb shock and carry loads in a wide variety of equipment and in a variety of applications. Exemplary thereof is the use of struts in aircraft allowing for movement of wing flaps, tail flaps and the like. Struts are also used in aircraft, particularly in the landing gear thereof. A strut may also be used in the mechanism to raise and lower the landing gear or it may be used to absorb the shock of an impact when the wheel on a landing gear assembly contacts the ground surface in a landing. In effect, and in this type of situation, the strut will be mounted with respect to the wheel and the frame of the aircraft in order to absorb this impact.

In most cases, struts are formed of structural metals, such as steel or the like, since they are designed to carry a substantial portion of the force of an impact. Exemplary of U.S. patents in which struts are used in aircraft are U.S. Pat. No. 5,366,181, dated Nov. 22, 1984 to Hansen and U.S. Pat. No. 4,821,983 to Aubry et al. The use of struts in other structures such as forks for two wheeled vehicles are shown, for example, in U.S. Pat. No. 5,609,349, dated Mar. 11, 1997, to Buckmiller et al. and in arches in U.S. Pat. No. 5,244,669, dated Jul. 6, 1993, to Guimbal.

The use of filament wound struts is also well known in the prior art and are identified, for example, in U.S. Pat. No. 4,740,100, dated Apr. 26, 1988, to Saarela et al. and in U.S. Pat. No. 4,336,868, dated Jun. 29, 1982, to Wilson et al. as well as U.S. Pat. No. 6,299,109 B1, dated Oct. 9, 2001, to Stephan et al. It is, of course, recognized that filament wound struts can be as effective, and frequently more effective than, struts made from heavy metal counterparts. Moreover, they provide a lighter weight than some of the metal counterparts which is, of course, highly advantageous in aircraft and like structures.

One of the significant problems which arises in the use of filament containing struts is the fact that the struts may be frequently required to transmit both tension loads and compression loads. If loads of this type are transmitted into a composite strut through an edge bearing or otherwise a shear mode, the composite material is not adapted for reacting to such loads. The composite material is highly effective in tension loads but not in compression and edge bearing loads and in shear loads. Consequently, and while filament reinforced composite struts can be highly effective in a variety of applications, they are limited, to some extent, by their ability to react both compression and shear modes of loading.

There is also a wealth of prior art which teaches of the method of making filament wound struts. However, none of this prior art has provided any effective means of producing a strut which is capable of reacting to shear loading and to edge bearing loading. Consequently and heretofore, there has not been any effective filament wound strut or any method of making same which is capable of reacting to both of these loads as well as transmitting tension loads. It would therefore be highly desirable to provide a strut, as well as a method of making same, which could effectively react both edge bearing and shear modes of load.

### OBJECTS OF THE INVENTION

It is, therefore, one of the primary objects of the present invention to provide a filament wound strut which is highly effective in reacting to both tension and compression loads and which also reacts both shear and edge bearing modes of force.

It is another object of the present invention to provide a filament wound strut of the type stated which can be used in a wide variety of applications including, but not limited to, for example, aircraft and like applications.

It is a further object of the present invention to provide a filament wound strut of the type stated which can be constructed of an isotropic pre-form wound with filamentary reinforcement therearound and having an axis at which load is to be transferred.

It is another object of the present invention to provide a method of making a filament wound strut and which is made in such manner that it will effectively transfer loads and react both tension loads and compression loads.

It is also an object of the present invention to provide a method of making a filament wound strut in such manner that load which is transferred into the composite avoids unfavorable edge bearing and shear modes of force transfer.

It is an additional object of the present invention to provide a method of manufacture of a filament wound strut having the desired axial stiffness through axially oriented fibers and the required strength in the fork or lug sections thereof to readily transmit shear and edge bearing loading.

The present invention generally provides a strut which can be used in a wide variety of load transmitting applications, and which is formed of filamentary material arranged in such manner that it can be used in a variety of such load transmitting applications and which is made in a relatively inexpensive and minimal labor involved process.

With the above and other objects in view, my invention resides in the novel features of form, construction, arrangement and combination of parts and components presently described and pointed out in the claims.

### SUMMARY OF THE INVENTION

The present invention relates in broad terms to both a filament wound strut capable of effectively reacting to a variety of load conditions, as well as a method of making the strut. The filament wound strut may preferably, although not necessarily, have a cylindrically shaped elongate section with relatively flat ends tapering into the elongate section. The ends are specially constructed so as to have relatively flat opposed surfaces, such as upper and lower surfaces, with a quasi-isotropic pre-form incorporated therein and with filament type reinforcement wound around the periphery thereof in a racetrack type arrangement. This construction is highly effective in that the winding will react to tension loads, and the inner laminate reacts to compression loads. Moreover, the laminate is constructed so that it will reduce the effects of load transfer through edge bearing and shear.

A method of producing the strut is also provided. In accordance with the method, a quasi-isotropic pre-form is initially made, generally of an outer oval shape. The pre-form is made from a quasi-isotropic laminate structure as, for example, a plurality of layers of either structural or non-structural materials which are laminated together. A suitable filamentary material is thereupon wound around the periphery of the isotropic laminate in order to form a load transfer insert for an end of the strut.

A mandrel is provided and typically is mounted on a shaft enabling rotation of the mandrel. The shaft may extend completely or partially through the mandrel. In addition, mandrel end portions, preferably formed of a metal such as steel or aluminum, are physically attached to the end of the mandrel. The mandrel end portions transition into tapered sections which, in turn, become contiguous with and transition into the cylindrically shaped body of the mandrel. The metallic end portions can be removable. The mandrel itself could be formed of any of a variety of materials, such as, solid foam, thin-walled plastic or washable sand, meltable eutectic alloy or the like.

Filament reinforcing material is wound about the entire mandrel in order to produce the strut. Either wet or pre-impregnated filamentary material may be used in the winding process and this winding process produces the required axial stiffness. Thereafter, the mandrel, with filamentary reinforcement wound thereon, can be consolidated and polymerized with a suitable autoclaving process.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of one form of strut which may be constructed in accordance with and which embodies the present invention;

FIG. 2 is a perspective view of a pre-form or insert used in the making of the invention and showing the winding of a filamentary material around the periphery thereof;

FIG. 3 is a top plan view of the insert of FIG. 2 and having a load transfer pin and bearing extending therethrough and which allows for transfer of the load from an apparatus in which the strut is used to the strut;

FIG. 4 is a top plan view of a slightly modified form of insert having somewhat of an oval shape;

FIG. 5 is a perspective view showing a strut with a cylindrically shaped body and relatively flat end sections thereon integrally merging into the body;

FIG. 6 is a fragmentary side elevational view showing one stage in the process of winding filamentary material about the pre-form of an insert and on the periphery thereof to produce the insert;

FIG. 7 is a plan view and showing the winding process for forming the insert of the invention;

FIG. 8 is a perspective view, partially broken away, and showing a mandrel with an end portion thereon carried by an axially extending support shaft used in the winding process;

FIG. 9 is a fragmentary sectional view of the arrangement of FIG. 8;

FIG. 10 is an exploded perspective view showing components forming the mandrel assembly which can be used to alter the length thereof but to maintain a constant transition between the central cylindrically shaped elongate section and the end sections thereof;

FIG. 11 is a perspective view, partially in dotted lines, and showing the formation of one of the end portions and supported on a support shaft; and

FIG. 12 is a fragmentary side elevational view, partially in section, and showing a technique for autoclaving the strut thus formed.

### DETAILED DESCRIPTION OF A PREFERRED EMBODIMENT

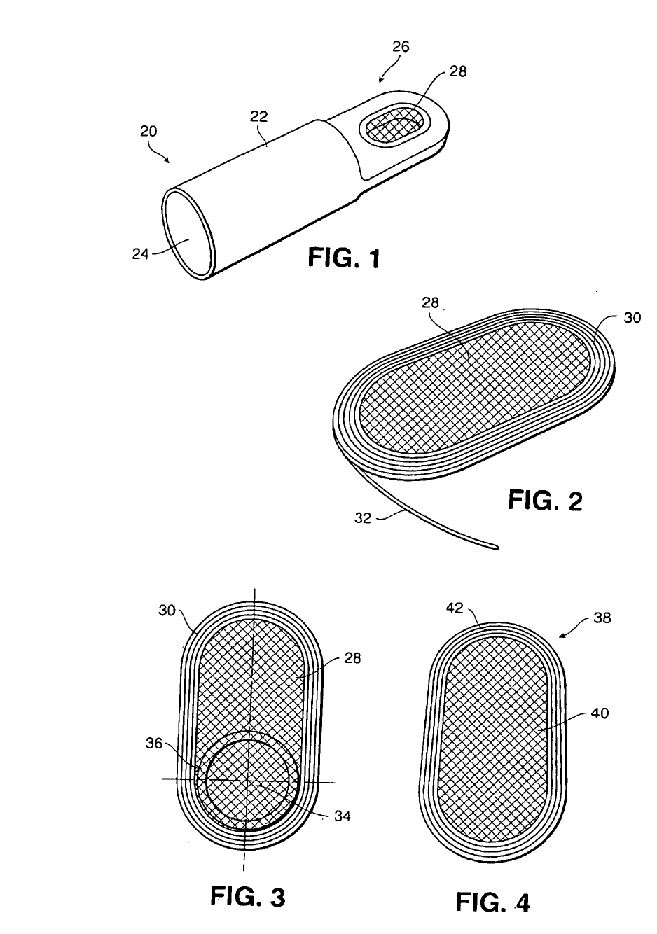

Referring now in more detail and by reference characters to the drawings, 20 designates one form of strut which may be constructed in accordance with the present invention and includes a cylindrically shaped body 22 as best shown in FIG. 1. In this particular embodiment, the body 22 is shown as being hollow having an interior bore 24. However, in many cases, the cylindrical body 22 will be of solid cross-section.

The body 22 is primarily formed of filament wound material. Generally, the body can be formed of any reinforced composite material and can be actually formed in any conventional filament winding operation. The mandrel used in the winding process may become in-situ and remain in the strut as produced. Exemplary of the filament reinforcement are filaments of carbon, glass, boron and the like. Moreover, the filaments can be cured in either a thermosetting resin or a thermoplastic resin. A well known number of thermosetting and thermoplastic resins are available for this purpose.

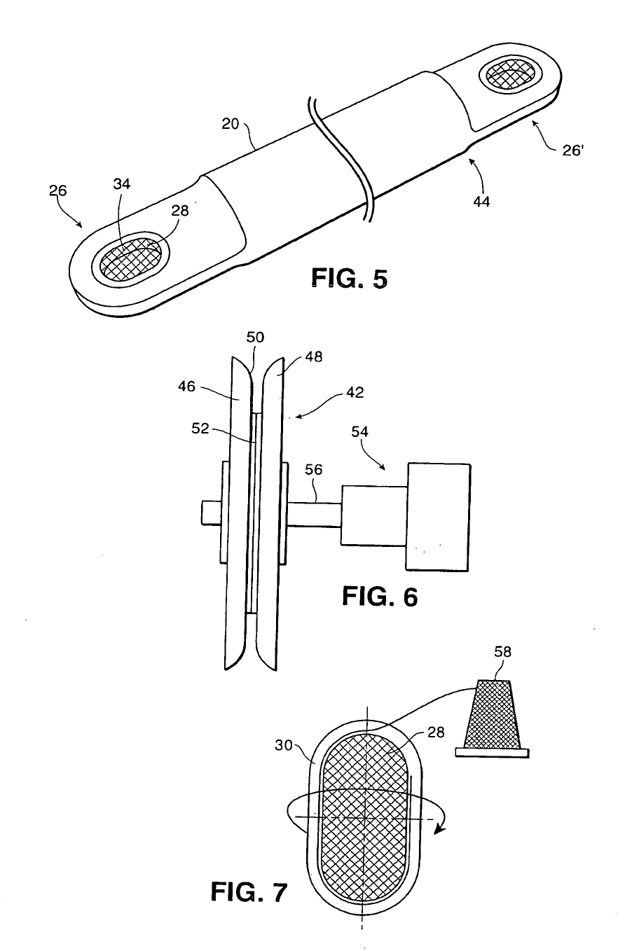

The cylindrically shaped body integrally merges into at least one relatively flat end section 26, as best shown in FIGS. 1 and 5 of the drawings. Each flat end section, if more than one, is comprised of a load transfer insert 27 further comprised of a quasi-isotropic core 28 and a filament wound peripheral reinforcing strip 30 and overwound with additional filament reinforcement, all formed in a manner as hereinafter described in more detail.

The quasi-isotropic core 20 with winding thereon, functions as a load transfer insert 27. Each insert comprises a pre-form in that it has been formed prior to the band winding. The filamentary material on the periphery thereof is wound about the pre-form in order to form the peripheral strip 30 or band. This process is hereinafter described in more detail. However, by reference to FIG. 2, it can be observed that a filament containing strand 32 is being wound about the periphery of the pre-form or load transfer core 28.

The core 28 is preferably eliptically shaped or oval shaped with opposite flat surfaces. One end of the load transfer insert 27 essentially identifies an axis at which the load is transferred and typically includes a pin 34 extending transverse to the plane of the core 28 as shown in FIGS. 2 and 3. Moreover, it can be observed by closer reference to FIGS. 2 and 3, that the pin 34 is actually fitted within a bushing 36 inserted into and embedded in the core 28.

It should be observed that the pin 34 and the bushing 36 are located in proximity to one end of the core 28. Moreover, the pin and the bushing are located equidistantly from the outer edges of the peripheral strip.

FIG. 4 shows a modified form of load transfer insert 38 which is similar in construction to the load transfer structure 28. In this case, the load transfer insert 38 is similarly formed of a quasi-isotropic core 40 along with a peripheral strip 42. However, the load transfer structure 38 conforms to a true oval shape, as opposed to the shape shown in FIGS. 2 and 3 which has flatter longitudinal edges and connecting rounded edges. In this respect, the load transfer insert could adopt other shapes, such as, for example, somewhat of a rectangular shape, preferably without sharp corner portions.

FIG. 5 shows one form of a strut 44 having a cylindrical body 20 with end sections 26 and 261 formed thereon. In this case, the end section 261 is substantially identical in construction to the end section 26. It is to be noted that the end sections are actually formed in the shape of lugs. However, the end sections could be in the form of a fork or any other structure which may be used for securement to another portion of a structural member.

The process for producing the strut of the present invention is more fully illustrated in FIGS. 6-12 of the drawings. In particular, the method starts with the formation of the load transfer insert 27. Generally, the core 28 is a quasi-isotropic laminate, preferably formed of fabric or plastic material. The laminate will have an almost uniform strength in any direction across the generally planar surface thereof. Inasmuch as the pin 34 and the bushing 36, in combination, lie very close to the wound filament peripheral strip 30, the laminate could be formed of any of a plurality of either plastic sheet materials or, for that matter, reinforced composite materials.

In the winding process, as shown in FIG. 6, the load transfer insert is initially formed from a pair of discs 46 and 48 facing one another with inner rounded angular edges 50 and which form a gap 52 therebetween. Filamentary material is wound in this gap 52 to form the reinforced plastic peripheral strip 30. In this case, the reinforcement may be pre-impregnated or otherwise impregnated as it is wound and deposited in the gap 52. By continuously building up the reinforcement in that gap 52, it is possible to form a racetrack shape peripheral strip of the desired cross-sectional thickness.

FIG. 7 more fully illustrates the winding of the peripheral strip 30 on the quasi-isotropic laminate core 28. By continuous rotation of the discs 46 and 48 in a winding operation, the filament will be deposited in the gap 52. For this purpose, it can be observed there is a portion of a winding apparatus 54 illustrated in FIGS. 6 and 7 including a rotatable shaft 56 for mounting of the plates 46 and 48 to thereby form the load transfer insert. There is also provided a winding apparatus 58 for payout of filament from a spool and winding same to form the peripheral strip.

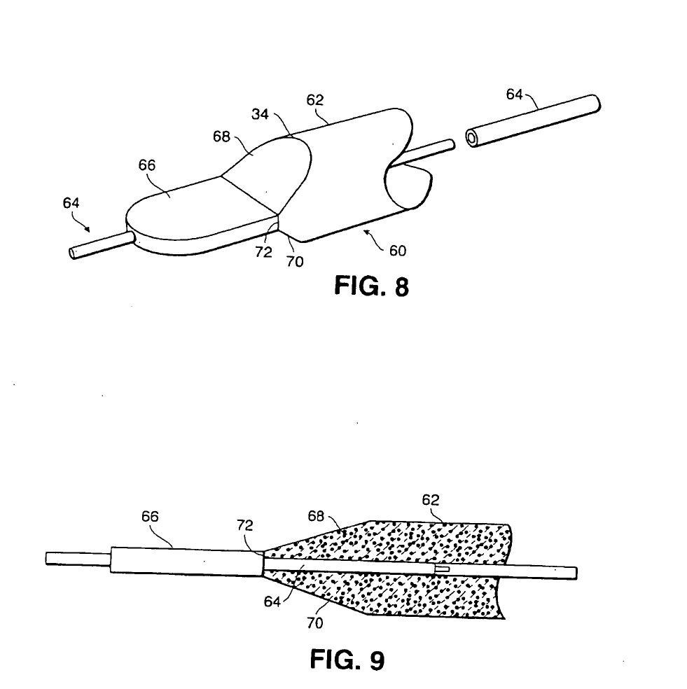

After formation of the load transfer insert, the formation of the remaining portion of the strut can be accomplished in the manner as best shown in FIGS. 8-12 of the drawings. In this case, there is provided a mandrel 60 having a cylindrically shaped mandrel body 62 which can be made from a variety of materials. For example, the mandrel could be made from a solid foam material, a thin walled plastic, washable sand, a meltable eutectic alloy, or the like. Any material which can be formed of the desired shape and will maintain at least its structural integrity can be used for this purpose.

The mandrel is preferably mounted on a mandrel shaft 64. The mandrel shaft may extend only partially inward into the mandrel 62 or, otherwise, it can extend fully axially therethrough as shown in FIGS. 8 and 9 of the drawings. The shaft is merely designed to hold the mandrel so that the mandrel can be rotated in a filament winding operation. Otherwise, it is possible to rotate a winding head about the mandrel although it is preferable to rotate the shaft 64 and the mandrel 60 thereon.

After the mandrel has been mounted on the shaft 64 it is possible to apply an end plate 66 to one end of the mandrel. In this case, it can be observed that the mandrel has opposite tapered surfaces 68 and 70 which would merge into the flat plate 66. Thus, the flat plate 66 would have one edge 72 which would abut against the tapered portion of the mandrel, all in the manner as best shown in FIGS. 8 and 9 of the drawings. Only one flat plate 66 is shown in FIGS. 8 and 9. However, assuming that the strut was going to adopt the general configuration and shape as shown in FIG. 5, then plates 66 would be located at each of the opposite axial ends of the mandrel.

In the actual process, the load transfer insert 28 is actually inserted into an opening in a metal plate, such as the metal plate 66. Although that opening is not necessarily shown in the metal plate 66 in FIGS. 8 and 9, that opening would be formed to accommodate the load transfer insert. As indicated previously, the load transfer insert is made by using the quasi-isotropic laminate surrounded by filament material wound on the periphery thereof. The depth of the filament would be determined depending upon the desired end use of the strut.

After the load transfer inserts are inserted into the end plate 66 and possibly an additional end plate at the opposite end of the mandrel, the mandrel 62 is mounted upon a shaft 64 and this is followed by mounting of the end plate in immediately abutting relationship to the edge 72. In this position, filament winding can then commence.

The filament is wound upon the mandrel 62 and the end plates in order to form the desired strut. In this respect, either the mandrel itself and/or the plate or plates 66 could become an integral part of the strut during the formation thereof. Preferably they are removed.

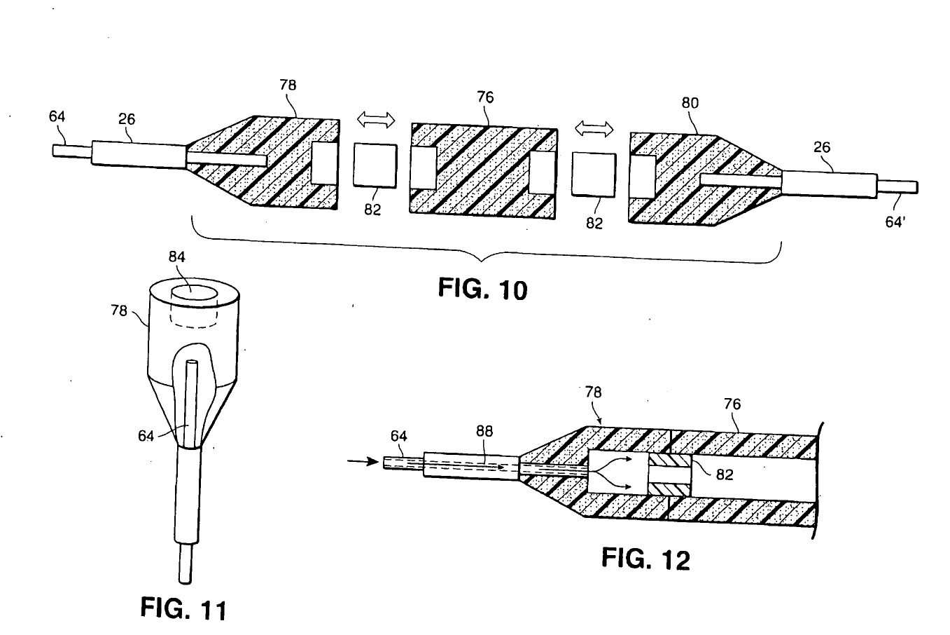

FIG. 10 more fully illustrates one method of making the strut so that various struts can be formed with differing lengths thereof. In the embodiment as shown in FIG. 10, there is provided a mandrel 76 which is, again, hollow to receive a shaft, such as the shaft 64. In addition, there would be provided mandrel end sections 78 and 80 which are secured to ends of the mandrel. Again, these mandrel-end sections 78 and 80 would be hollow to receive the shaft 64. The metal end plates used in the formation of the strut, such as the end plates 26, would then also be disposed on the mandrel, all in the manner as best shown in FIG. 10 of the drawings.

Cylindrical extension connecting tubes 82 would be used for securing the mandrel 76 to the mandrel end sections 78 and 80. These connecting tubes would be inserted in the hollow bore of these various components so as to allow the mandrel end section 78 to abut against and effectively become contiguous with the mandrel 76 and to also allow the mandrel end section 80 to abut against and become contiguous with the mandrel 76. Filament winding would then occur in the same manner as previously described in order to provide a strut of the type as shown in FIG. 5. In this respect, a number of struts could be formed with this construction with different lengths by varying the length of the mandrel. In addition, it can also be understood that various end sections can be formed. Thus, and for example, a lug can be formed at one end of the strut and a fork can be formed at the opposite end of the strut.

FIG. 11 illustrates one mandrel end portion with the plate thereon. In this case, the mandrel end section is shown with a hollow bore 84 capable of receiving one of the stub tubes 82. Moreover, it can be observed that the mandrel end 78, for example, is hollow as shown to accommodate the shaft 64.

FIG. 12 illustrates an embodiment where a pair of shafts are used, such as the shafts 64 and 641 as illustrated in FIG. 11. Each of these mandrel shafts may preferably be hollow in construction. In the embodiment as shown, the end sections 78 are mounted on this shaft and this is followed by the mounting of the end plates thereon. The mandrel itself, 76 would similarly be mounted on this shaft. In accordance with this construction, if the mandrel shaft 64 is hollow and is provided with a central duct 88, autoclavable gas, such as hot air under pressure, can be introduced into the mandrel after the filament winding process and either before or after the curing thereof. This will, in effect, operate as an autoclaving process to consolidate the filaments in the resin and to polymerize the resin.

As indicated previously, the metallic portion of the plates can be removed and the remainder of the flat plate section, including the load transfer element as shown in FIG. 2, could remain in the strut. The mandrel extremities being provided with removable metallic plates will form the interior surface of the end.

Thus, there has been illustrated and described a unique and novel filament wound strut and method of making same and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

1. A load bearing strut formed primarily of a reinforced plastic composite and reacting tension and compression loading as well as minimizing effects of edge bearing and shear loading, said strut comprising:
a) an elongate section comprised of a reinforced composite material;
b) at least one relatively flat end section on an end of said elongate section; and
c) a load transfer insert in said end section formed of a quasi-isotropic material surrounded by a fiber reinforcing strip and having a portion therein for conducting load transference, such that the laminate reacts compression loads and the fiber reinforcing strip reacts tension loads and reducing load which would result in edge bearing and shear.

2. The load bearing strut of claim 1 further characterized in that said end section has a shape different than that of said elongate section and having portions which merge into a shape of the elongate section so that the two sections become effectively contiguous.

3. The load bearing strut of claim 1 further characterized in that said elongate section has a cylindrically shaped portion for a substantial portion of its length and that said end section is a relatively flat plate.

4. The load bearing strut of claim 3 further characterized in that said end section has a pair of relatively flat oppositely disposed surfaces and a section which merges into a cylindrically shaped elongate section.

5. The load bearing strut of claim 1 further characterized in that said load transfer insert has a somewhat oval shape with a pair of opposite flat surfaces and that the portion therein for conducting load transference is located closer to one end of said oval-shaped portion.

6. The load bearing strut of claim 1 further characterized in that said strut is covered by an outer layer of fiber reinforcing material such that the elongate section and the end section are covered by the fiber reinforcing material wound thereabout.

7. A load bearing strut formed primarily of a reinforced plastic composite material and capable of reacting tension and compression loads while minimizing the effects of edge bearing and shear loading, said strut comprising:
a) an elongate section having a rounded portion thereon and being comprised of at least a reinforced composite material;
b) at least one relatively flat end section on said elongate section and having a portion which merges into the rounded shape of said elongate section and also a relatively flat plate-like section thereon and which plate-like section has flat opposed surfaces; and
c) a load transfer insert in said end section and having an insert core surrounded by fiber reinforcing material, said load transfer insert also having a portion therein adjacent one end portion thereof for conducting load transference, such that the laminate reacts compression loads and the fiber reinforcing strip reacts tension loads while reducing loads which would result in edge bearing and shear.

8. The load bearing strut of claim 7 further characterized in that said end section has a shape different than that of said elongate section and having portions which merge into a shape of the elongate section so that the two sections become effectively contiguous.

9. The load bearing strut of claim 1 further characterized in that said opposite faces of said end portion are formed of an insert core material and said end section is provided with a peripheral band of reinforcing material wound thereon.

10. The load bearing strut of claim 7 further characterized in that the entire strut is wound with filament reinforcing material.

11. A process for producing a load bearing strut capable of reacting to tension and compression loads while minimizing shear and edge bearing loads, said process comprising:
a) wrapping a peripheral edge of a preformed member with a filamentary reinforcing material to produce a load transfer insert;
b) locating said load transfer point in an end of an elongate member and with the elongate member and load transfer insert having the overall shape of the strut to be produced;
c) providing a load transfer insert in proximity to one end of said core; and
d) wrapping filament reinforcing material about said elongate member and said end of the elongate member having the load transfer insert therein to provide a load bearing strut.

12. The process for producing the load bearing strut of claim 11 further characterized in that the insert is somewhat oval shaped and the process comprises wrapping the filament in a somewhat oval pattern.

13. The process for producing the load bearing strut of claim 12 further characterized in that said insert is formed of a quasi-isostropic material.

14. The process for producing a load bearing strut of claim 12 further characterized in that said process comprises inserting said load transfer insert into an end plate secured to an elongate member, and winding filament reinforcing material about said end plate and said elongate portion.
